(19) United States
(12) Patent Application Publication
(10) Pub. No.: US 2008/0313342 A1
(43) Pub. Date: Dec. 18, 2008

(54) METHOD FOR TRANSMITTING FILES BASED ON NETWORK DIGITAL SIGNAGE SYSTEM

(75) Inventor: May Wu, Taipei (TW)

Correspondence Address: WPAT, PC;INTELLECTUAL PROPERTY ATTORNEYS, 2030 MAIN STREET, SUITE 1300, IRVINE, CA, 92614, US

(73) Assignee: CHIEF SYSTEM TECHNOLOGY CO. LTD,, Taipei (TW)

(21) Appl. No.: 11/764,399

(22) Filed: Jun. 18, 2007

(51) Int. Cl. G06F 15/16

(52) U.S. Cl. 709/230

(57) ABSTRACT

The present invention relates to a method for transmitting files based on network digital signage system comprising
(1) obtaining an authentication from a media server upon starting a network media player file server (NMP FS);
(2) making an initiation of the NMP FS;
(3) delivering a command to the NMP FS;
(4) delivering schedule information to the NMP FS; and
(5) transmitting media files from the media server to the NMP FS.

### FIELD OF THE INVENTION

The present invention relates to a method for transmitting files based on network digital signage system.

### DESCRIPTION OF PRIOR ART

Digital signage is a novel technology which can help elevating the brand image of an enterprise, targeting the potential consumers and providing related information for their decision making. Digital signage broke the limitation of traditional advertisement by its diverse content, multi-division display and eye-attractive conceptions, delivering the ads to the target group directly and effectively. Undoubtedly, digital signage would have become the promising marketing tool in the new era. Info Trends/CAP Ventures, the US market survey institution, indicated that the market of digital signage will increase from 550 million USD in 2003 to a predicted value of 2 billion USD in 2009, the growth rate is 364%. The digital signage not only can be used in the crowded places such as stations, malls and retail stores, but can be applied in banks, beauty salons, and the health hookup system in the hospitals where consumers should wait a period of time. Through the combination of digital signboard, touchscreen and diverse digital video and audio contents, digital signage further raised the trend of bilateral communication between consumers and advertisers. In the era of Web 2.0, the paradigm of retail business is shifting from the flow of commodities to the flow of services. Moreover, the integration of physical channels and the virtual, mobile communication also make integrated networks and interactive contents enter into stores. The development of digital signage industry stands for the rise of a new business model and its unlimited application. The digital signage was also introduced to the health hookup system with large-scale screen installed in the waiting room of a clinic so as to broadcast the educational video and the health care information provided by hospitals, pharmaceutical companies or consumer goods manufacturers.

However, the replacement of ads of existing digital signage system is carried out by manpower periodically or by file transmission through local area network, resulting in the high cost of labor and time. Furthermore, the existing system failed to real-time control the specific ads to show in specific time and location according to consumer's schedule accurately. Consequently, the existing system cannot fit the need of extensive distribution and flexibility of digital signage, causing the low efficiency of media files transmission. Hence, developing a system which can real-time control the digital signage through the internet will solve above problems effectively.

US patent publication No. 2002094787 provided an interactive telecommunication system for interconnecting a viewer with an object being viewed. US patent publication No. 2007050372 provided systems and methods for creating, managing and publishing advertisements. US patent publication No. 2006015531 provided a device, system and method for digital signage.

### SUMMARY OF THE INVENTION

The present invention relates to a method for transmitting files based on network digital signage system comprising

(1) obtaining an authentication from a media server upon starting a network media player file server (NMP FS);

(2) making an initiation of the NMP FS;

(3) delivering a command to the NMP FS;

(4) delivering schedule information to the NMP FS; and

(5) transmitting media files from the media server to the NMP FS.

### BRIEF DESCRIPTION OF THE DRAWINGS

FIG. 1 indicates the process of the present invention.

FIG. 2 indicates the authentication process between media server and NMP FS. FIG. 3 indicates the process of command delivery between media server and NMP FS.

FIG. 4 indicates the communication protocol and process of schedule delivery.

FIG. 5 indicates the connection of file transmission among media server, NMP FS and NMP.

FIG. 6 indicates the operation procedure of file transmission between media server and NMP FS.

FIG. 7 indicates the operation procedure of file transmission between NMP FS and NMP.

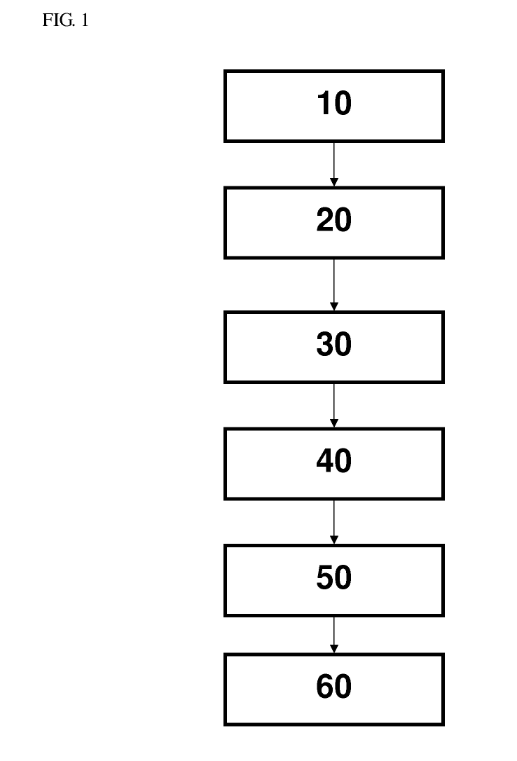

### DESCRIPTION OF MAJOR PARTS IN THE PRESENT INVENTION

10: obtaining an authentication from a media server upon starting a network media player file server (NMP FS)

20: making an initiation of the NMP FS

30: delivering a command to the NMP FS

40: delivering schedule information to the NMP FS

50: transmitting media files from the media server to the NMP FS

60: transmitting the schedule information and the media files from the network media player file server (NMP FS) to a plurality of network media players (NMPs) inside a group

### DETAILED DESCRIPTION OF THE INVENTION

### TERM DEFINITION

Digital Signage

Digital signage is a form of out-of-home advertising in which content and messages displayed on an electronic screen, or digital sign, can be changed without modification to the physical sign, typically with the goal of delivering targeted messages to specific locations at specific times. Digital signage offers superior return on investment compared to traditional printed signs. Digital signs may be scrolling message boards, LCD or plasma display panels, electronic billboards, projection screens, or other emerging display types like Organic LED screens that can be controlled electronically using a computer or other devices, allowing individuals or groups to remotely change and control their content. The content displayed on digital signage screens can range from simple text and still images to full-motion video, with or without audio.

Network Digital Signage

A digital signage broadcasting system with network function which transmits and updates media files via wide area network (WAN) or local area network (LAN).

Media Server

The operation server which manages the uploading and downloading of media files and functions as an interface for system administrators.

Network Media Player, NMP

A digital media player which decodes and plays various video files format of industrial standard and connects with media server as well as other NMPs by its internet connective function.

Network Media Player File Server, NMP FS

A network media player which is designated as an intermediary role in a group of NMPs in the same local area network, it is in charge of transmitting media files from media server and then transmits the media files to other NMPs in the group. NMP FS increases the efficiency of network.

The purpose of the present invention is to provide the protocol of file transmission between media server and NMPs, to increase the efficiency of file transmission and the extent of automation, further satisfying the need of data security.

By the method provided by the present invention, one can establish a network digital signage system to provide real-time and location-specific multi-media advertisement with high quality by using a central management structure, solving the problem of inconvenience resulted from traditional method of replacement by manpower.

The present invention provides the protocol of authentication and connection between media server and network media players in the network digital signage system, the protocol of transmission and update of schedule information and media files between media server and NMP FS, and the protocol of media files transmission between NMP FS and NMP. The method provided by the present invention can increase the efficiency of file transmission, ensure the security of data, and fulfill the purpose of automatic updating

The present invention can be applied to NMP group framework. Namely, every NMP belongs to a specific group where an NMP FS in the aforesaid group is designated to exchange signals and update the schedule information and media files from media server. Then the NMP FS makes commands to all of the NMPs in the group to download the media files according to the schedule information.

The present invention provides a method for transmitting files based on network digital signage system comprising (1) obtaining an authentication from a media server upon starting a network media player file server (NMP FS); (2) making an initiation of the NMP FS; (3) delivering a command to the NMP FS; (4) delivering schedule information to the NMP FS; and (5) transmitting media files from the media server to the NMP FS.

The method provided by the present invention further comprises a step of transmitting the schedule information and the media files from the network media player file server (NMP FS) to a plurality of network media players (NMPs) inside a group after step (5). After receiving the media files from media server, NMP FS makes commands to all of the NMPs in the group to update the schedule information. NMPs then download the media files according to the updated schedule information. By way of the two-step transmission manner described above, the efficiency of digital signage system and the speed of file update can be enhanced.

In the method provided by the present invention, an authentication step is executed as a first step. Upon the starting, NMP FS obtains an authentication from the media server in order to ensure that the NMP FS is legal and the protocol between NMP FS and media server is correct.

After the completion of the authentication step, an initiation step is executed by the NMP FS to confirm the synchronization of date and time between NMP FS and media server as well as the setting of NMP FS.

After the completion of initiation step, the media server delivers a command to the NMP FS. If the type of connection is File Stream, NMP FS would deliver a command to media server for download of the media files. Then the media server transmits the media files to the NMP FS.

In the method provided by the present invention, the command and the media files are transmitted through different threads independently. Building up two threads for transmission increases the data security and transmission efficiency.

In the present invention, the step of command delivery is followed by the step of schedule information delivery. The schedule information is selected from the group consisting of attribute, size, location, date and time of broadcasting of the media files. The format design of the schedule information is favorable for delivery of schedule information.

In the present invention, the NMP FS checks the availability of space for storage after receiving the schedule information, avoiding the problem of insufficiency of space for storage during the transmission of media files.

After the completion of the delivery of schedule information, NMP FS requests for the download of the media files from the media server. The transmission of the media files between media server and network media player is carried out by a two-step manner. At first, the media server transmits the media files to the NMP FS, and then the NMP FS transmits the media files to the NMPs in the group. The two-step transmission manner alleviates the burden of wide area network and increases the efficiency of file transmission.

The method provided by the present invention further comprises a step of dividing the media files before the transmission of the media files and a step of combining the media files after the transmission of the divided media files. Dividing the media files before transmission reduces limitation of the transmission of large media files. Therefore, the time-consuming re-transmission is avoided by way of the division-combination process.

While the invention has been described and exemplified in sufficient detail for those skilled in this art to make and use it, various alternatives, modifications, and improvements should be apparent without departing from the spirit and scope of the invention.

One skilled in the art readily appreciates that the present invention is well adapted to carry out the objects and obtain the ends and advantages mentioned, as well as those inherent therein. The processes and methods for producing them are representative of preferred embodiments, are exemplary, and are not intended as limitations on the scope of the invention. Modifications therein and other uses will occur to those skilled in the art. These modifications are encompassed within the spirit of the invention and are defined by the scope of the claims.

### EXAMPLES

The following examples are offered by way of illustration and not by way of limitation.

### Example 1

### Authentication Step 10

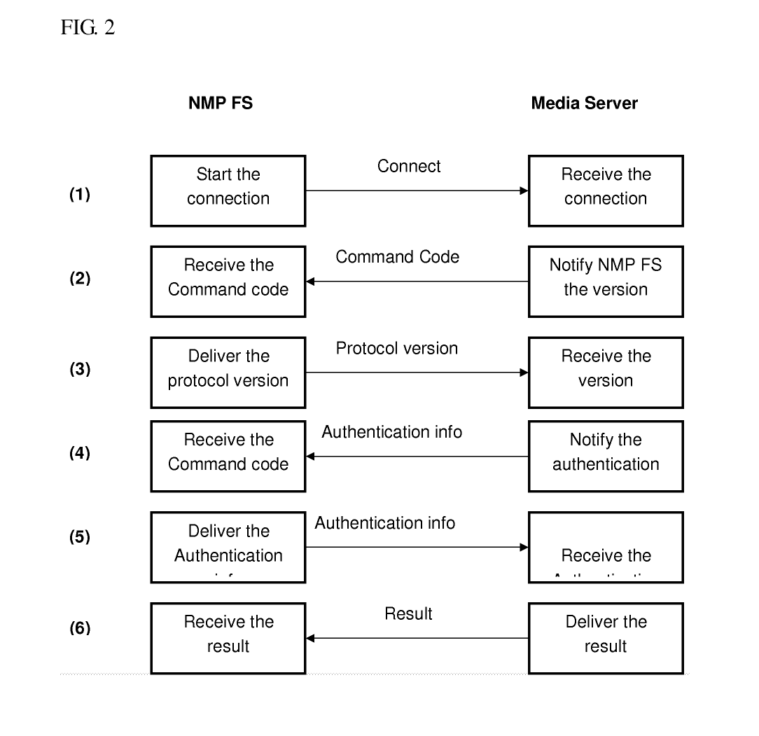

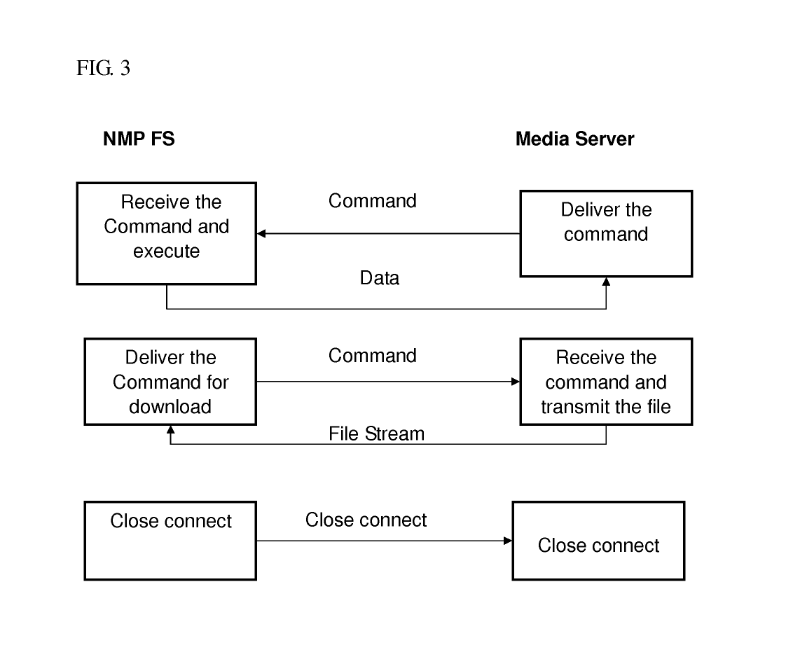

As the indication of FIG. 2, the NMP FS obtained an authentication upon starting to ensure the correctness and the security of the connection between NMP FS and media server. After the completion of the authentication step, the threads for delivery of command and schedule information were then established. The authentication step was described as follows:
(1) NMP FS automatically connected to the media server to request for an authentication upon starting. After the success of the authentication 10, the connection would keep open until shut down of the NMP FS.
(2) After the success of the connection, the media server requested the NMP FS to deliver the present protocol version. The NMP FS established in different timeframe may use different protocol version. Therefore, the media server would not proceed with the following steps such as signal or files transmission unless the protocol version of the NMP FS has been confirmed.
(3) After receiving the instruction from the media server, the NMP FS delivered the present protocol version back to the media server.
(4) After receiving the present protocol version, the media sever requested the NMP FS to deliver the authentication information.
(5) The NMP FS delivered the authentication information to the media server. For an instance, the authentication information was described as below:

Length: 18

Format: TXX:XX:XX:XX:XX:XX

Wherein T stands for the type of connection whose possible value was listed below:

C (Command) stands for the connection used in command delivery. After authentication, the work in the initiation step would be executed.

F (File Stream) stands for the connection used in media file transmission. After authentication, the work in the initiation step would not be executed.

XX:XX:XX:XX:XX:XX stands for the MAC Address of the NMP FS. The media server would check whether the MAC Address was effective or re-connected. The prior connection would be replaced if the MAC Address was re-connected. Then the media sever delivered the result of authentication (success or failure) back to the NMP FS.

### Example 2

### Initiation Step 20

After authentication, the initiation step would be executed if the connection is for command delivery. The initiation step was described as follows:
(1) The synchronization of date: the date of media server and NMP FS should be synchronized to ensure the accuracy of display.
(2) The synchronization of the playlist of the media server. It was for the purpose of replacement of the media server in the future.
(3) Designation of the role of NMP FS or general NMP.

### Example 3

### Delivery of the Command 30

As the indication of FIG. 3, the media server began to deliver the command to NMP FS after the completion of the authentication step 10 and initiation step 20. NMP FS would deliver a command to the media server for file download if the type of connection was File Stream. Then the media server transmitted the media files to the NMP FS.

### Example 4

### Delivery of the Schedule Information 40

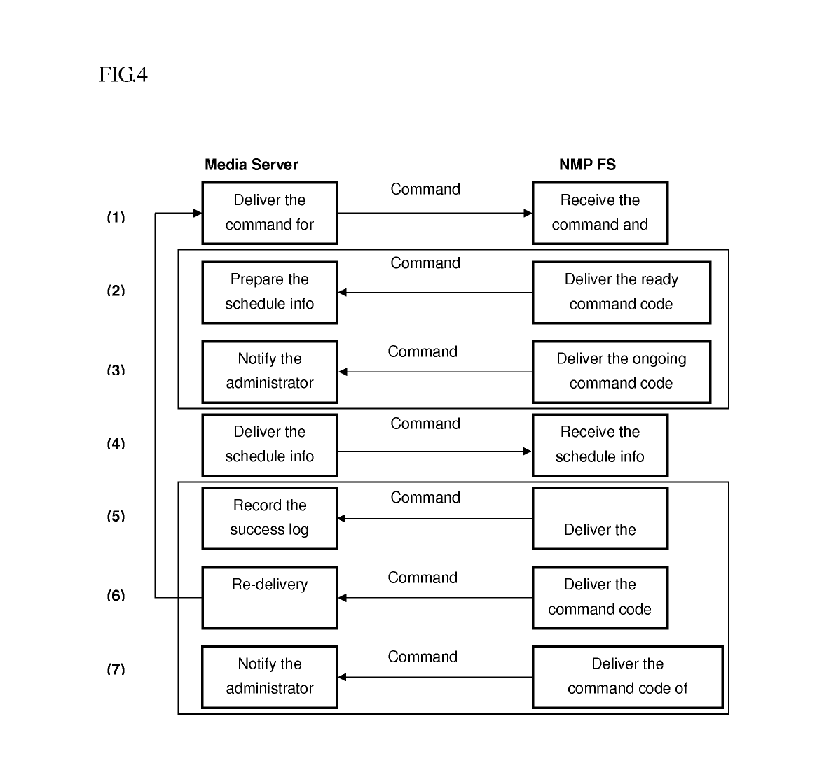

As depicted in FIG. 4, the delivery and execution of schedule information was a key step in the operation of digital signage system. It ensured that the media files in the playlist would be broadcasted on schedule. There were two ways to initiating the delivery of schedule information. The one is that the media server automatically initiated the delivery on the basis of the schedule set by the system. The other is that the system administrator entered the schedule information to initiate the delivery process by manpower. The process was described as follows:
(1) At first, the media server made a command to the NMP FS to receive the schedule information. For an instance, the command was described as below:

Length: 18

Format: TYYYY/MM/DD

Wherein T stands for the type of display whose possible value was listed below:

C stands for entrusted by client.

S stands for self display.
(2) The NMP FS delivered the prepared command back to the media server.
(3) If the NMP FS was engaged in the process of file transmission, it would send a “transmitting” signal back to the media server, then the administrator would deliver the present schedule information later.
(4) If the NMP FS was ready, the media server would delivered the schedule information as below:

Length: the length of the schedule information

Checksum: a kind of code to ensure that the received information was identical with the delivered information

Format: the contents of the schedule information (as described in Example 5)
(5) The NMP FS would send a success signal back to the media server after the completion of reception of the schedule information. Then the media server would record the success signal for further confirmation.
(6) If the reception of the schedule information was failed, the NMP FS would send a failure signal to the media server. After receiving the failure signal, the media server would record the failure log and resume the delivery of schedule information.
(7) After receiving the schedule information, the NMP FS would compute the capacity for download according to the size of the media files. If the capacity was not sufficient, then the NMP FS sent the “lack of capacity” signal back to the media server. The media server would inform the administrator by e-mail.

### Example 5

### The Format Design of the Schedule Information

The schedule information contained the detailed data of every media file including attribute, size, location, date and time of broadcasting. The format was described as follows:

[ITEM]

StartDate=Apr. 25, 2007;

EndDate=Apr. 25, 2007;

StartTime=02:52:04;

EndTime=23:52:04;

Source=MEDIA; //type of display—media file

Output=VGA; //the interface of image output VGA(DVI/LVDS/VGA/COMPONENT/SVIDEO/COMPOSITE)

Everyday=TRUE; //whether the media file was broadcated everyday

SlideDelay=2; //the display time (second) of every slide (if the media files were pictures)

FileIndex=1; //the present index value of group display

FileNum=1; //the total number of group display

Repeat=TRUE; //whether the media file was broadcated repeatedly

PlayTimes=−1; //the playtimes could be designated if Repeat=FALSE

Pathname=media/Taxi3_WMVHD_Extract.wmv; //the route of display of the media file and the file name (relative to the storage device/main route)

[ITEM]

StartDate=Apr. 25, 2007;

EndDate=Apr. 25, 2007;

StartTime=02:52:04;

EndTime=23:52:04;

Source=SLIDE; //type of display-slide

Output=VGA;

Everyday=TRUE;

SlideDelay=3; 113 seconds for every figure

FileIndex=−1;

FileNum=−1;

Repeat=TRUE;

PlayTimes=−1;

Pathname=slides/*.*; //

[ITEM]

StartDate=Apr. 25, 2007;

EndDate=Apr. 25, 2007;

StartTime=02:52:04;

EndTime=23:52:04;

Source=STREAM; //type of display-internet streaming files

Output=VGA;

Everyday=TRUE;

SlideDelay=3;

FileIndex=1;

FileNum=1;

Repeat=TRUE;

PlayTimes=−1;

Pathname=http:H/216.228.115.13/downloads/nZone/videos/nvidia/nalu.wmv

### Example 6

### The File Transmission Among the Media Server, the NMP FS and NMPs

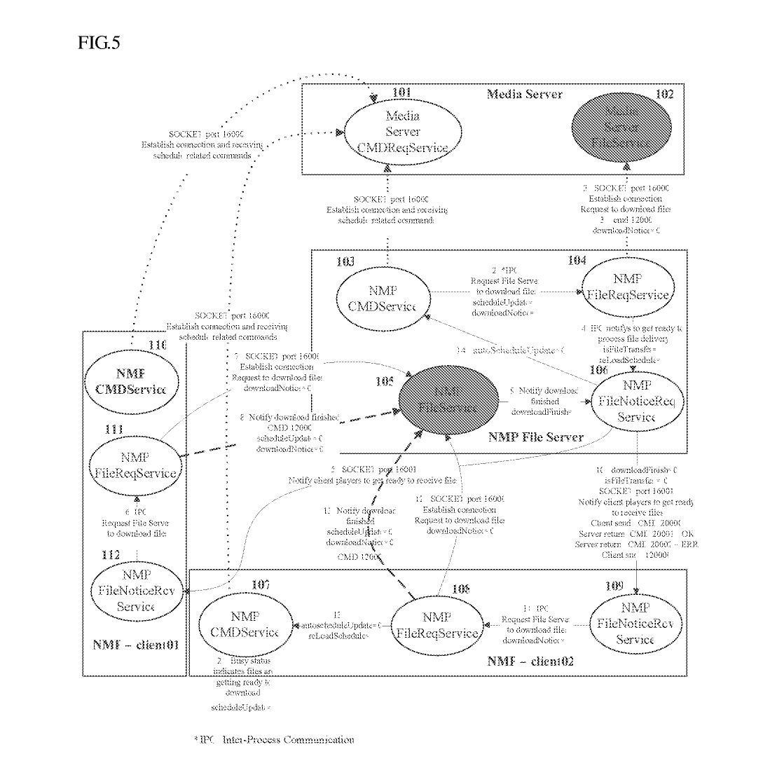

As indicated in FIG. 5, NMP FS checked whether the media files listed on the playlist has been existed after completion of the reception of the schedule information. If the media file on demand was absent, NMP FS requested for download of the file from media server. After receiving the command, the media server divided the media file into several smaller files and transmitted to NMP FS in order. NMP FS combined the divided files to the original media file after the competion of the reception. Then the NMP FS initiated the process of file transmission to other NMPs in the group.

### Example 7

### The Process of File Transmission Between Media Server and NMP FS 50

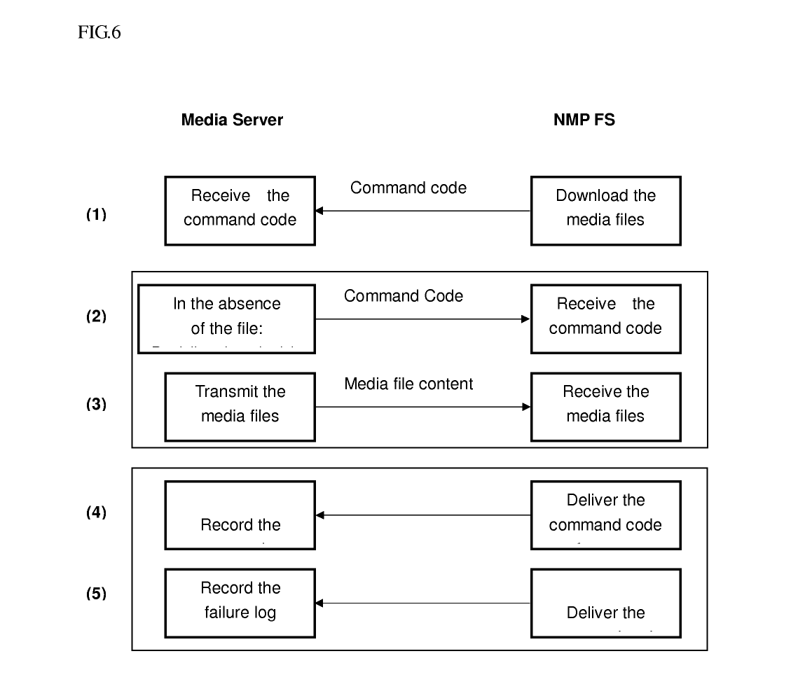

As described in FIG. 6, the process was as below:
(1) NMP FS checked whether the media files listed on the playlist has been existed after completion of the reception of the schedule information. If the media file on demand was absent, NMP FS requested for download of the file from media server. At this time, two threads would be established between the NMP FS and the media server. One thread was used for command delivery from the NMP FS to the media server such as the thread between Media Server CMDReqService of GUI 101 and Media Server CMDReqService of GUI 103 in FIG. 5. The other thread was specifically used for media file transmission such as the threads between Media Server FileService of GUI 102 and Media Server FileService of GUI 104 in FIG. 5. Making the threads for different purposes be operated independently raised the reliability and the efficiency of transmission. The thread for media file transmission would be shut down when the transmission was completed. At first, the NMP FS delivered a command to media server to inform the file name on demand:

Length: the length of the file name

Format: XXX.XXX
(2) The media server would deliver a “not existing” command back to NMP FS if the media files requested by NMP FS were not available.
(3) If the media server found the requested file, it would take the file and divide it into several files then transmit to NMP FS. The divided files were transmitted through the thread between Media Server FileService of GUI 102 and NMP FileReqService of GUI 104 in FIG. 5. The file extension name of the divided files were denoted by the serial number. The format of file transmission was described as below:

Length: the length of the file content

Checksum: the checksum of the file content

Format: the file content

The default value of buffer size during transmission was 80 K.
(4) After receiving all the divided files, the NMP FS would send a success signal to the media server and combine the divided files to the original media file. Then the NMP FS proceeded to the transmission of next media file until all the media files on the schedule information were downloaded.
(5) If the reception of the media files failed, NMP FS would send a failure signal to the media server and request for re-transmission.

### Example 8

### The File Transmission Process Between the NMP FS and the NMP 60

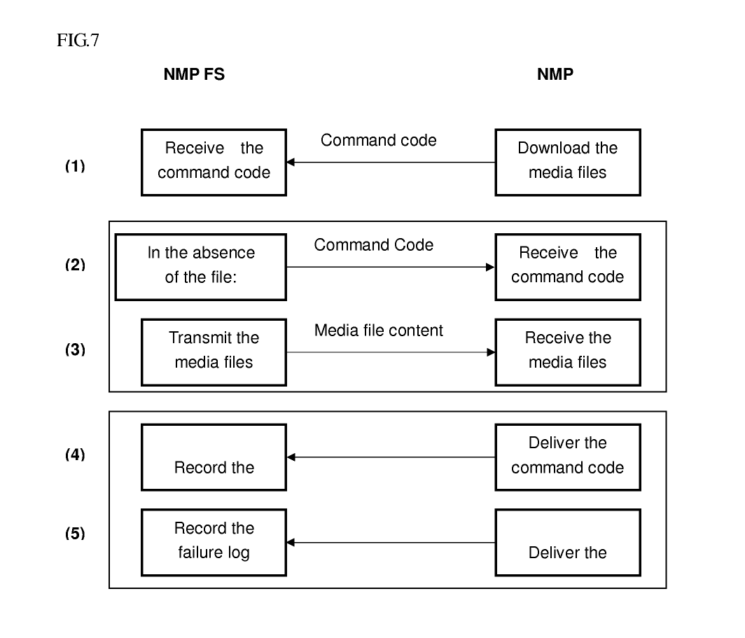

As indicated in FIG. 7, after receiving the media files from the media server, the NMP FS delivered the schedule information and transmitted the media files to NMPs in the group in order. The protocol and mechanism involved in the process was almost identical with that between media server and NMP FS. Two specific threads were established for command delivery and file transmission, respectively. For example, the thread between NMP FileNoticeReq Service of GUI 106 and NMP FileNoticeRcv Service of GUI 109 was specific for command delivery; the thread between NMP FileService of GUI 105 and NMP FileReqService of GUI 108 was specific for file transmission. NMP FS divided the media file into several smaller files after receiving the command, and then transmitted the files to NMPs in order. NMPs combined the divided files to the original media file after reception of all the files. The above process would repeat until every NMP received the media file. The process was described as follows:
(1) NMP checked whether the media files listed on the playlist has been existed after completion of the reception of the schedule information. If the media file on demand was absent, NMP requested for download of the file from the NMP FS. At first, the NMP delivered a command to the NMP FS to inform the file name on demand:

Length: the length of the file name

Format: XXX.XXX
(2) The NMP FS would deliver a “not existing” command back to NMP if the media files requested by NMP FS were not available.
(3) If the NMP FS found the requested file, it would take the file and divide it into several files then transmit to NMP. The divided files were transmitted through the thread between NMP FileService of GUI 105 and NMP FileReqService of GUI 108 in FIG. 5. The file extension name of the divided files were denoted by the serial number. The format of file transmission was described as below:

Length: the length of the file content

Checksum: the checksum of the file content

Format: the file content

The default value of buffer size during transmission was 80 K.
(4) After receiving all the divided files, the NMP would send a success signal to the NMP FS and combine the divided files to the original media file. Then the NMP proceeded to the transmission of next media file until all the media files on the schedule information were downloaded.
(5) If the reception of the media files failed, NMP would send a failure signal to the NMP FS and request for re-transmission.

What is claimed is:

1. A method for transmitting files based on network digital signage system comprising
(1) obtaining an authentication from a media server upon starting a network media player file server (NMP FS);
(2) making an initiation of the NMP FS;
(3) delivering a command to the NMP FS;
(4) delivering schedule information to the NMP FS; and
(5) transmitting media files from the media server to the NMP FS.

2. The method as claimed in claim 1, which further comprises a step of transmitting the schedule information and the media files from the network media player file server (NMP FS) to a plurality of network media players (NMPs) inside a group after step (5).

3. The method as claimed in claim 1, wherein the command and the media files are transmitted through different threads independently.

4. The method as claimed in claim 1, wherein the schedule information is selected from the group consisting of attribute, size, location, date and time of broadcasting of the media files.

5. The method as claimed in claim 1, wherein the NMP FS checks the availability of space for storage after receiving the schedule information.

6. The method as claimed in claim 1 and 2, wherein transmission of the media files between media server and network media players (NMPs) is carried out by a two-step manner.

7. The method as claimed in claim 1 and 2, which further comprising a step of dividing the media files before the transmission of the media files.

8. The method as claimed in claim 1 and 2, which further comprising a step of combining the media files after the transmission of the divided media files.
